(19) United States
(12) Patent Application Publication
(10) Pub. No.: US 2002/0046030 A1
(43) Pub. Date: Apr. 18, 2002

(54) Method and apparatus for improved call handling and service based on caller's demographic information

(76) Inventors: Jayant Ramaswamy Haritsa, North Plainfield, NJ (US); Daniel Francis Lieuwen, Somerville, NJ (US)

Correspondence Address: Docket Administrator (Room 3J-219), Lucent Technologies Inc., 101 Crawfords Corner Road, Holmdel, NJ, 07733, US

(21) Appl. No.: 09/858,362

(22) Filed: May 16, 2001

Related U.S. Application Data
(60) Provisional application No. 60/205,038, filed on May 18, 2000.

(51) Int. Cl. G10L 15/14; G10L 15/00

(52) U.S. Cl. 704/256

(57) ABSTRACT

Information that is latent in a caller's voice is processed for purposes of improving the handling of the call in any type of voice-interactive application. This implicit information in a caller's voice is not related to the actual words being said but rather to the characteristics of how those words are being said. This information, related to the caller's unique demographic profile, is used to decide how to respond to the caller for improved business performance. For example, by estimating the age and the gender of a caller based on his/her voice signal, a vendor associated with a calling center or Web site is able to make a sophisticated choice of what advertisement to present to the user or how to formulate a response to the caller. Similarly, this latent voice information can be used to determine which agent is likely best suited to handle a call with a caller with an estimated demographic, with the caller then being connected to that agent. Further, the caller may be provided with information that is best associated with a person having the estimated characteristics. This information may take the form of the presentation of an advertisement geared to be of interest to a person having those characteristics. The estimated characteristics can also be used to provide personalized service and add security to transactions.

### CROSS-REFERENCE

This application claims the benefit of U.S. Provisional Application No. 60/205,038, filed May 18, 2000.

### TECHNICAL FIELD

This invention relates to providing customized service to a caller based on his or her implicit demographic information.

### BACKGROUND OF THE INVENTION

Currently, customers can encounter two kinds of electronic interactive services: (1) Web-based services, where the mode of interaction is a keyboard or a mouse connected to a computer; or (2) call centers, where the interaction is through touch-tone telephone interfaces. Of late, these services have become increasingly voice-automated, where the system allows the caller to navigate the site using voice commands. Even more recently, there has been a merger of both Web-based services and call center interactive voice response services through the use of a phone markup language formerly known as PML and now referred to as VoiceXML. This new Web-based service enables a caller/user to retrieve and navigate the Internet through voice commands and retrieve certain Web pages, which are translated by a telephone/IP server into speech for delivery to the callers telephone set (see, e.g., “PML: A Language Interface to Networked Voice Response Units”, by J. C. Ramming, Workshop on Internet Programming Languages, ICCL'98, Loyola University, Chicago, Ill., May, 1998). Similarly, the callers voice commands are translated into IP requests that are output to the IP network and transmitted to the appropriate Web server on which the Web pages of interest are stored. Such interaction is effected through the telephone/IP server, which terminates the telephone network on one side and the IP network on the other. The ability for an end user at an audio terminal, such as a telephone, to access the Internet through such a server is described in, for example, International Application Published Under the Patent Cooperation Treaty (PCT), Publication Number WO 97/40611 entitled “Method and Apparatus For Information Retrieval Using Audio Interface”, published Oct. 20, 1997 and, “Integrated Web and Telephone Service Creation”, Bell Labs Technical Journal, pp. 19035, Winter 1997. These publications are incorporated herein by reference.

No matter whether through Web-based or conventional IVR services, voice enabling provides a convenient and attractive service for users, with concomitant economic advantage to the vendors in terms of automation and services.

### SUMMARY OF THE INVENTION

We have realized that additional information is latent in a caller's voice that can be processed for purposes of improving the handling of the call in any type of voice-interactive application. These applications include a call center that forwards an incoming call to an agent, or provides an interactive service which supplies the caller with automated information, or the afore-described arrangement using VoiceXML where a user is able to surf the Web and retrieve Web pages and information in an audio format through a telephone/IP server using voice commands. Specifically, this latent information within a caller/user's voice can be used by a business offering services or products through a call center or a Web server to its economic advantage. This implicit information in the caller's voice is not related to the actual words (i.e., lexicality) being said but rather to the characteristics of how those words are being said. This information is related to the caller's unique demographic profile and that information can be used to decide how to respond to the caller and improve business performance. For example, by estimating the age and the gender of a caller based on his/her voice signal, the vendor associated with a calling center or Web site can make a more sophisticated choice of what advertisement to present to the user or how to formulate a response to the caller. Similarly this latent voice information can be used to determine which agent is likely best suited to handle a call with a caller with the estimated demographic, with the caller then being connected to that agent. Thus, the speech signal itself can be considered as a new data resource and mined for valuable information.

Accordingly, in accordance with the present invention, a caller's voice input is processed and the voice pattern is analyzed to detect certain demographic characteristics that are likely to be relevant for continued processing of the call. After these relevant demographic characteristics are estimated, the call is handled in a manner that might provide a more favorable interactive environment for a person having those characteristics. Thus, the estimated demographic information can be used to determine how information is to be communicated back to the caller and/or what information is to be communicated back to the caller. Thus, for example, the interaction may continue in manner that is likely to instill confidence in the caller by using a voice that has an accent similar to that of the caller, or is of the same gender as the caller, or is from a similar age group as the caller, all of which characteristics can be estimated from the caller's voice. Further, the caller may be provided with information that is best associated with a person having those characteristics. This information can take the form, for example, of the presentation of an advertisement geared to be of interest to a person having those characteristics, or direction of the incoming call to a particular agent at a call center who is best suited to deal with a person having those characteristics, or with whom previous marketing data has shown that a caller with such characteristics is likely to make a purchase from. The present invention can also be used in conjunction with other prior art functionalities, such as caller-id, to identify a specific member of a known household and thus provide personalized service and add security to transactions.

### BRIEF DESCRIPTION OF THE DRAWING

FIG. 1 is a block diagram of a call center arrangement using the present invention;

FIG. 2 is a flowchart detailing the steps of the present invention; and

FIG. 3 is a block diagram of a system incorporating VoiceXML, which uses the present invention.

### DETAILED DESCRIPTION

Many aspects of speech signals give indicators about the speaker's personal characteristics. Acoustic characteristics like voice pitch is an indicator of whether the speaker is an adult or a child, and also give indications regarding gender. Prosody, which is related to accent, intonation, volume, etc., can provide indicators about a person's social, and ethnic background. These acoustic and prosodic characteristics can be explicitly determined, or can be implicitly modeled using statistical models. These acoustic and prosodic characteristics as opposed to the actual word content, or lexicalilty, of what is being said can then be used separately or together in analyzing the characteristics of a caller's voice signal and used as factors that are considered in handling an incoming call.

Various well-known models developed for speaker identification and verification can also be applied to estimating the characteristics of a caller's voice for purposes of handling an incoming telephone call. The use of Hidden Markov Models (HMMs) is a standard technique used in speech processing. In accordance with this technique, a collection of voices that has a desired characteristic (e.g., male versus female, child versus adult, northerner versus southerner, senior citizen versus adult non-senior citizen) are processed through an HMM to produce a scoring function. A subsequently received unknown voice is then processed through several HMMs for these different characteristics. The unknown voice is then scored against these models to determine which class or classes to associate the speaker with. Then, depending on the scoring and the particular HMMs through which the speaker's voice is processed, the speaker can be characterized by different factors as for example, gender, age, geographic origin, ethnicity, and social background.

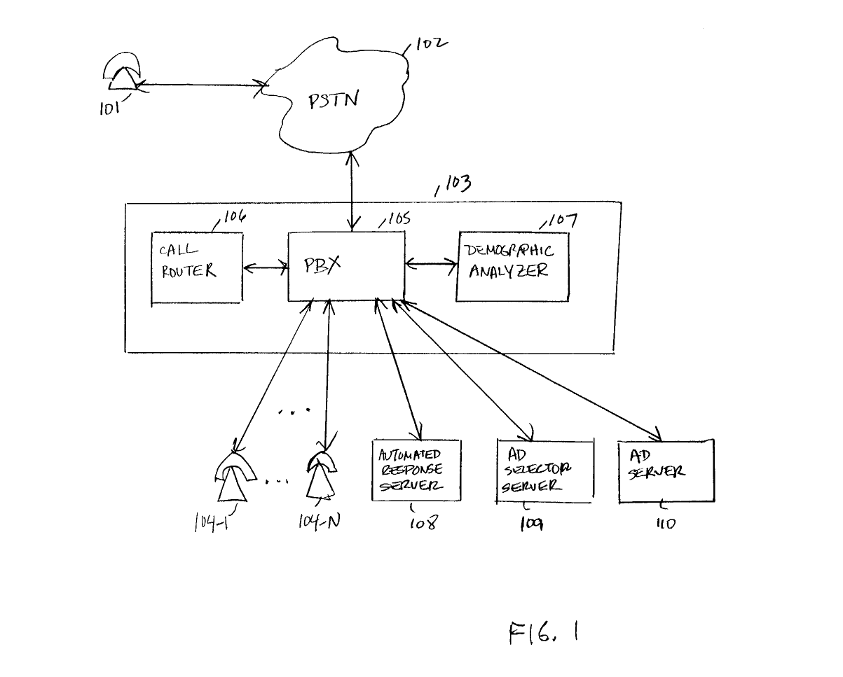

In accordance with the present invention, these non-lexical characteristics of a caller's voice, independent of the words uttered by the user, are used to determine how a call is to be handled. FIG. 1 shows a block diagram of a system in which the present invention is used to direct calls to an appropriate agent in a call center. In this exemplary embodiment, a calling party at a audio-capable terminal, such as telephone 101, places a call over a network, such as the public switched telephone network (PSTN) 102, to an organization, business or otherwise, having a call center 103 as its interface with a plurality of agents at terminals 104-1 - 104-N. Although shown as the PSTN, the network over which the call is placed can be a wired, or wireless network telephone network, electrical or optical, a cable TV network, an IP network, or any other type of network over which a user's voice signal can be transmitted in either analog or digital format. Terminal 101, although shown in FIG. 1 as a telephone set, can be any type of terminal, as for example, a computer terminal or a set-top TV interface, that is capable of converting a user's speech input into an appropriate signal, analog or digital, for transmission over the network. Also, in the call center arrangement of FIG. 1, the agents' terminals, shown as telephones 104-1 -104-N, can be any type of terminal, as for example, a computer terminal with associated voice capabilities that enables an agent to handle the call. Further, an incoming call may be directed not to an agent but rather to a server that provides an automated response to the user that is determined, at least in part, in accordance with characteristics associated with the callers voice signal. That response can be an audio response or, depending on the type of terminal from which the call has originated, a video, a video with audio, or any type of computer-generated display incorporating audio, video, and/or text. The latter may include, for example, a Web page that is downloaded into a browser running on the user's computer terminal, or an email message that can be sent to user's email address. That email address can be provided to the system during the call, or outside the call.

Referring again to FIG. 1, call center 103 includes a PBX 105, which interfaces with PTSN 102, functioning to answer incoming calls and switching them to agents 104-1 - 104-N under the control of a call router 106. Call router 106 makes call routing decisions based in part on the results obtained by demographic analyzer server 107. Demographic analyzer server 107 records a segment of a caller's speech input, which PBX 105 prompts the caller for. It then scores that input against N different HMMs and selects a model with the highest score, as for example estimation that the caller is a woman or that the caller is a senior citizen. Alternatively, demographic analyzer server 107 could select plural non-conflicting models, such as a senior citizen southern woman. Further, if the processing power of the demographic analyzer is large enough, the caller's speech input can be processed in parallel in real time against the N different HMMs as the caller is speaking. Once the model or models are selected that best match the profile of the user, the information is passed to call router 106, which makes a decision as to how to handle the call based in part on the caller's estimated demographic information. Thus, for example, if the analysis shows the calling party likely to be a southern woman, then the call might be directed to an agent with a similar speech characteristic. Alternatively, the calling party's estimated demographic information can be forwarded to a terminal at which the agent is working and the agent, if appropriately trained and talented, can imitate that speech pattern and accent. Yet another option is that the call can be directed to an agent whom experience has shown to be most effective in interacting with a caller with the estimated demographic profile. Even further, an automated response server 108 can generate a computer-generated response that is in part a function of the caller's demographic information. That automated response can be generated in a “voice” that best matches the caller's estimated profile, or one that the business has determined to be most effective in dealing with a caller having that demographic profile.

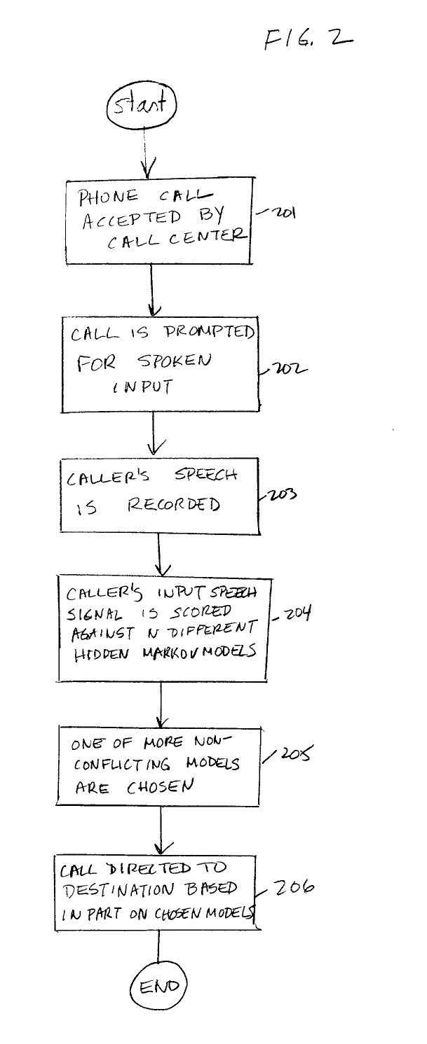

FIG. 2 shows the steps of the present invention as used in this exemplary call center environment in which incoming calls are directed for handling according to the demographic model that the calling party's speech best matches. At step 201, a calling party's phone call is received by the call center PBX. At step 202, the caller is prompted for spoken input. At step 203, the caller's speech input is recorded. At step 204, the caller's input speech signal is scored against N different HMMs. At step 205, the one or more non-conflicting models with the highest scores are chosen. At step 206, the call is directed to its destination based in part on the chosen one or more non-conflicting models with the highest score.

In addition to using the calling party's demographic information from the analysis of his speech to direct the call to an appropriate agent, that same information can be used to automatically generate an advertisement or other information that is tailored to a person having that profile. Thus, for example, a caller at telephone 101 could dial the “800” number of a familiar retailer. The retailer's call center PBX, 105 in FIG. 1, would prompt the caller to select an option from a voice menu. A script interpreter within the call center PBX 105 then records the caller's responsive utterance, “one” for example, and passes it to the demographic analyzer server 107. Demographic analyzer server 107 analyzes the recording and concludes that the speaker is most likely an adult male. It then creates an estimated profile (EP) document, which it returns to the call center. The “adult male” EP is then passed to an ad selector server 109, which chooses an advertisement for a product geared to an adult male, for example, shaving cream. The URL of that ad is returned to call center PBX 105, and an audio file referred to by the URL is requested from an ad server 110. Ad server 110 then returns that audio file to the call center PBX 105, and the shaving cream ad is played to the caller while he is on-line. Although shown in FIG. 1 as being directly connected to PBX 105, servers 108, 109 and 110 can be connected through another network such as the Internet.

The present invention can also be used to improve security. A “900” number service can deny access, or pass on to a human operator, if the analysis of the caller's voice reveals that the caller is likely to be a child. For credit or debit card-based transactions, the estimated demographic profile of the caller can be compared to the credit or debit card owner's stored profile. If a discrepancy exists between the estimated profile and the stored profile, the call can be routed to an operator for further verification.

The present invention can also be used to enhance caller-id functionality to provide personal services. Caller-id allows a merchant to identify the telephone line from which an incoming call is originating. If that telephone line is recognized as being associated with a known customer, or group of customers, the analysis of the caller's voice to obtain demographic information can be used to make a better guess as to which particular household member is on the line. For example, if several family members order from the same phone-order merchant, learning from the analysis of the caller's voice that the caller is a female adolescent from a household at a known telephone number enables the merchant to guess which particular member of the household that the caller is. The merchant can then personalize the service to that caller and add security measures automatically.

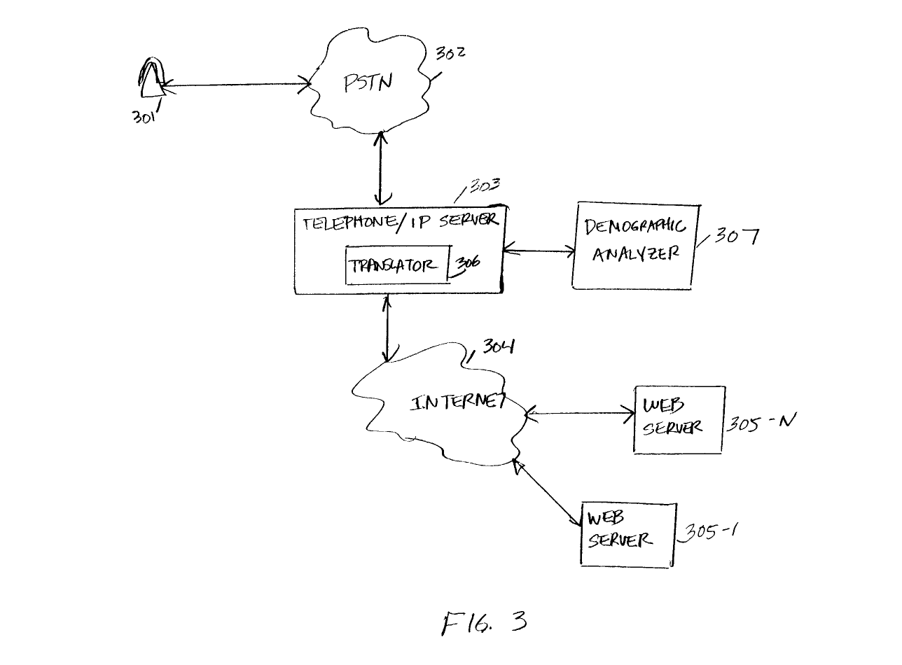

As previously discussed, the use of a phone markup language, referred to as VoiceXML, enables a user at a telephone to access the Web through a telephone/IP server. The user, using audio commands from his telephone set, is able to receive and interact with Web pages formatted in this phone markup language. The telephone/IP server, interconnecting the PSTN and the Internet, translates audio inputs into IP commands, which are outputted as requests onto the IP to retrieve Web pages. The responsive Web pages, formatted in VoiceXML, are then returned to the telephone/IP server where the textual components in those pages are translated into audio for playback to the user's telephone over the telephone network. FIG. 3 shows the user's telephone set 301 connected to the PSTN 302. The telephone/IP server 303 interconnects PSTN 302 and the Internet 304. A plurality of servers 305-1-305-N that are connected to the Internet 304, generate VoiceXML—formatted Web pages that are translatable by a translator 306 within server 303. In accordance with the present invention, a demographic analyzer server 307 connected to telephone/IP server 303 analyzes a voice sample uttered by the user at telephone 301. An estimated profile (EP) of that person is then returned to server 303. Server 303 can then use the information in that profile in several ways in determining how and/or what information will be presented to the user. In a first way, that EP can be used to select a particular “voice” among a plurality of different available voices to translate textual components of the VoiceXML—formatted Web pages received from servers 305-1-305-N. Thus, for example, if demographic analyzer 307 determines that the user is most likely to be a southern adult woman, a computer-generated voice of a southern adult woman may be used to translate the retrieved Web pages. A second use of the estimated demographic information can also be in determining a particular ad or other information to play back to the user, in a manner previously described. Thus, telephone/IP server 303 can forward the estimated profile together with the user's request to the destined server 305-1-305-N. The destined server can then use that estimated profile in formulating the content of the Web page to be delivered back to telephone/IP server 303 for translation into an audio signal for presentation to the user.

The foregoing merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be further appreciated by those skilled in the art that the block diagrams herein represent conceptual views embodying the principles of the invention. Similarly, it will be appreciated that the flow chart represents various processes that may be substantially represented in computer readable medium and so executed by a computer or processor, whether or not such computer or processor is explicitly shown.

In the claims hereof, any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

The invention claimed is:

1. A method comprising:
estimating demographic information associated with a user on a call at a terminal having audio capabilities from the user's voice characteristics that are independent of the content of the words uttered by the user; and
handling the call in accordance with the estimated demographic information.

2. The method of claim 1 wherein the user's voice characteristics include acoustic and/or prosodic characteristics.

3. The method of claim 1 wherein the demographic information is used to determine where to route the call.

4. The method of claim 1 wherein the demographic information is used to determine what information to provide to the user on the call.

5. The method of claim 3 where the demographic information estimated from the user's voice characteristics includes one or more of the user's gender, age, geographic origin, ethnicity, and social background.

6. The method of claim 5 where one or more of the user's estimated gender, age, geographic origin, ethnicity, and social background are used to determine the voice characteristics to respond to the caller with on the call.

7. The method of claim 5 where one or more of the user's estimated gender, age, geographic origin, ethnicity, and social background are used to determine an advertisement to present to the user on the call.

8. The method of claim 4 where the demographic information estimated from the user's voice characteristics includes one or more of the user's gender, age, geographic origin, ethnicity, and social background.

9. The method of claim 8 where one or more of the user's estimated gender, age, geographic origin, ethnicity, and social background are used to determine the voice characteristics to respond to the caller with on the call.

10. The method of claim 8 where one or more of the user's estimated gender, age, geographic origin, ethnicity, and social background are used to determine an advertisement to present to the user on the call.

11. A method comprising:
estimating demographic information associated with a user on a call at a terminal having audio capabilities from the user's voice characteristics that are independent of the content of the words uttered by the user;
comparing the estimated demographic information with known information about the user;
if the estimated demographic information matches the known information, handling the call in a first manner; and
if the estimated demographic information does not match the known information, handling the call is a second manner.

12. The method of claim 11 wherein the user's voice characteristics include acoustic and/or prosodic characteristics.

13. The method of claim 12 where the demographic information estimated from the user's voice characteristics includes one or more of the user's gender, age, geographic origin, ethnicity, and social background.

14. The method of claim 11 where the call includes a credit or debit card transaction and the demographic information estimated from the user's voice is compared with known demographic information associated with the owner of the credit or debit card.

15. A method comprising:
estimating from a user's voice characteristics, demographic information associated with the user on a call from a terminal having audio capabilities that originates from an identified telephone line;
identifying the user by comparing the user's estimated demographic information with demographic information associated with a plurality of potential known users at the identified telephone line; and
personalizing a response to the identified user on the call.

16. The method of claim 15 wherein the user's voice characteristics include acoustic and/or prosodic characteristics.

17. The method of claim 16 where the demographic information estimated from the user's voice characteristics includes one or more of the user's gender, age, geographic origin, ethnicity, and social background.

18. Apparatus comprising:
means for estimating demographic information associated with a user on a call at a terminal having audio capabilities from the user's voice characteristics that are independent of the content of the words uttered by the user; and
means for handling the call in accordance with the estimated demographic information.

19. The apparatus of claim 18 wherein the user's voice characteristics include acoustic and/or prosodic characteristics.

20. The apparatus of claim 18 wherein the demographic information is used to determine where to route the call.

21. The apparatus of claim 18 wherein the demographic information is used to determine what information to provide to the user on the call.

22. The apparatus of claim 20 where the demographic information estimated from the user's voice characteristics includes one or more of the user's gender, age, geographic origin, ethnicity, and social background.

23. The apparatus of claim 22 where one or more of the user's estimated gender, age, geographic origin, ethnicity, and social background are used to determine the voice characteristics to respond to the caller with on the call.

24. The apparatus of claim 22 where one or more of the user's estimated gender, age, geographic origin, ethnicity, and social background are used to determine an advertisement to present to the user on the call.

25. The apparatus of claim 21 where the demographic information estimated from the user's voice characteristics includes one or more of the user's gender, age, geographic origin, ethnicity, and social background.

26. The apparatus of claim 25 where one or more of the user's estimated gender, age, geographic origin, ethnicity, and social background are used to determine the voice characteristics to respond to the caller with on the call.

27. The apparatus of claim 25 where one or more of the user's estimated gender, age, geographic origin, ethnicity, and social background are used to determine an advertisement to present to the user on the call.
